(19) United States
(12) Patent Application Publication
(10) Pub. No.: US 2006/0000971 A1
(43) Pub. Date: Jan. 5, 2006

(54) Intelligent sensory platform for wireless two-way sensory surveillance

(75) Inventors: Richard A. Jones, San Francisco, CA (US); Earl D. Sacerdoti, Alamo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cellular Security and Surveillance Inc., San Francisco, CA (US)

(21) Appl. No.: 10/884,310

(22) Filed: Jul. 2, 2004

(51) Int. Cl. H01J 40/14

(52) U.S. Cl. 250/239

(57) ABSTRACT

A intelligent surveillance platform is provided with wireless two-way sensory surveillance in environments wherein the entire surveillance unit and its supporting structure fit within a standard light switch junction box and otherwise also functions as a light switch. The platform serves as a sensory ‘edge-of-network’ subsystem for use with a local controller, a central data center engine, and a central viewing platform. The edge-of-network sensory element includes sensors, intelligence and transceivers housed in a wall enclosure under a modified light switch faceplate that incorporates a built-in antenna. The sensors may include an embedded camera, microphone, passive infrared heat detector and odor detector. The intelligence includes memory and logic controller. The transceiver has two-way audio and at least one video channel for broadcast. Light switch wiring supplies power to the device, obviating the need for any specialist installation. A re-chargeable battery device built into the unit enables the device to operate maintenance free without the need to replace any parts over the expected life of the battery.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

This invention relates to remote sensing. More particularly, this invention relates to sensing, synthesizing, transmitting, receiving, analyzing and reporting of observations.

In the past, security alarm applications primarily provided audio only alarms with optional telephone connectivity to a remote monitoring facility in case an alert was triggered. More expensive video surveillance systems have been used wherein images are captured and stored, typically to a Video Cassette Recorder using videotape. These systems required the use of Closed Circuit TV (CCTV) cameras of relatively large size and preferably high resolution working in cooperation with staffed remote monitoring centers and employing hardwired, high-bandwidth dedicated connectivity, as well as expensive maintenance. In order to add remote visual verification, systems may have been upgraded to digital, requiring replacement of many of the analog components. Digital video cameras and sensors have typically been hardwired into a building, along with some cheaper form of communication, (telephone line or cable) to a remote monitoring center.

These prior art solutions were deficient in a number of key respects. In the case of audio alarm only products, which make up the overwhelming majority of residential security installations, audio has proved to be a weak deterrent, prone to false alarms, and as such, is widely ignored by police. Professional burglars now routinely cut or jam outgoing phone-lines and switch off the power to the house, rendering many systems useless. With no ability to monitor or visually verify a sensed event, both private security and police forces have no way to respond and no way of differentiating false alarms from real emergencies. Emergency services also have no two-way communications ability to deter criminals, to render emergency aid or help remotely, or to select the appropriate level of emergency care that could be based on or informed by visual and audio communication.

While video surveillance systems are becoming ubiquitous for remote monitoring in retail stores and town centers and for protection of industrial sites, the typical systems are expensive to install, operate and maintain. Video-based surveillance systems have a number of deficiencies. The units typically draw from the same power source as a VCR or PC-based system, and they need considerable battery backup or a generator in the event of a power-failure. If telephones lines are cut or jammed, no data is accessible off site. The cameras need to be hardwired for power and connectivity, which typically requires professional installation and which is a deterrent for adoption by consumers in their homes.

Wireless cameras are now widely available. However, they still typically need an external power connection and are prone to the well-known security and hacking problems of wireless networks. These systems typically require professional installation to work properly.

Light switch fixtures are known which incorporate additional features. Specifically light switches which are controlled by a motion sensor embedded in the switch fixture are known.

Many of the functions in known systems are not able to operate together because they are sold as separate product sets. For example, many video surveillance products do not support standard burglar alarm systems, and they do not interface seamlessly with other triggered devices, such as smoke detectors.

Inexpensive web camera-based systems can be breached easily and do not work in the absence of supplied external power. They are not reliable devices for use with third-party monitoring applications. They also require Internet access to operate.

What is needed for individual private mass-market adoption is an easy-to-install two-way embedded sensory platform useful in a surveillance system. The device must be reliable and tamper-resistant, with little need for service, professional installation or even battery replacement. Such a system must operate with a variety of communications technologies and under various lighting conditions and be remotely programmable based on learned events at the installation. Further, such a system must incorporate two-way communication.

### SUMMARY OF THE INVENTION

According to the invention, an intelligent surveillance platform is provided with wireless two-way communication and sensory surveillance in environments, wherein the entire surveillance unit and its supporting structure fit within a standard light switch junction box and otherwise also functions as a light switch and serve as a replacement for a standard light switch, installable with no modification or addition to existing wiring. The platform serves as a sensory ‘edge-of-network’ subsystem for use with a local controller, a central data center engine, and a central viewing platform. The edge-of-network sensory elements includes sensors, intelligence and transceivers housed in a wall enclosure under a modified light switch faceplate that incorporates a built-in antenna. The sensors may include an embedded camera for images, a microphone for sound, a motion detector, a heat detector and an odor detector. The intelligence includes memory and logic controller. The transceiver can transmit and receive control and status information on at least one charnel, together with two-way audio and video. Light switch wiring supplies power to the device, obviating the need for any specialist installation when used to replace an existing switch. A module built into the unit accommodates a re-chargeable battery device enabling the apparatus to operate maintenance free without the need to rely on mains power for extended periods.

The object of the invention is to provide an inexpensive, unobtrusive system for two-way communication and sensory surveillance that provides a very high degree of reliability and longevity without the need for expensive custom installation and maintenance.

To this end, a system according to the invention incorporates embedded two-way (bi-directional) wireless transceivers into a conventional light switch fitting for communicating sensory observation information and data, peer-to-peer to and from each device, hub-and-spoke to and from a local controller, or remotely to an Internet-coupled monitoring facility. The transceiver includes a radio frequency transmitter. The intelligent light switch with the transmitter broadcasts sensory data, such as images and sound, and, in the case of overhead mounting, reported detection of smoke, back to a radio receiver with an embedded controller, which processes the information and further transmits the processed information via common communications methods, such as radio wave, radio telecommunications, via the Internet, telephone line or the like, to a monitoring center or other facility or monitoring person.

The invention will be better understood by reference to the following detailed description in connection with the accompanying drawings.

### BRIEF DESCRIPTION OF THE DRAWINGS

FIG. 1 is a front view of a cover plate of a platform according to the invention.

FIG. 2 is a side view of a platform according to the invention.

FIG. 3 is an exploded view of the device of FIG. 1 or 2 in accordance with the invention.

### DESCRIPTION OF SPECIFIC EMBODIMENTS OF THE INVENTION

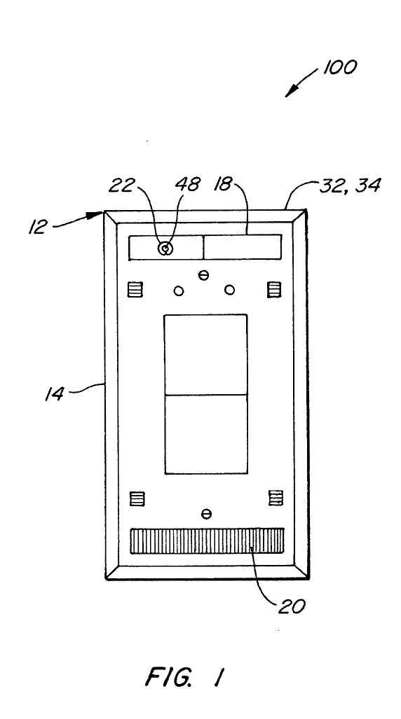

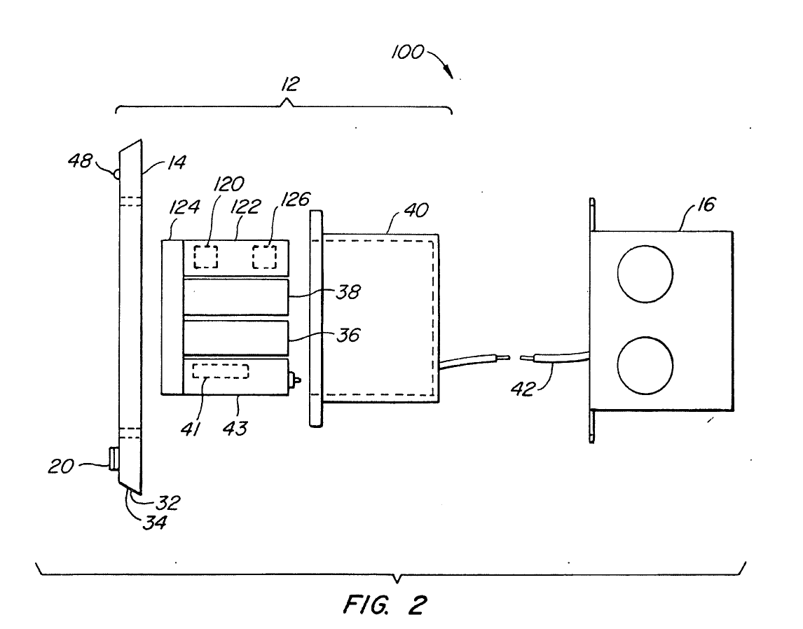

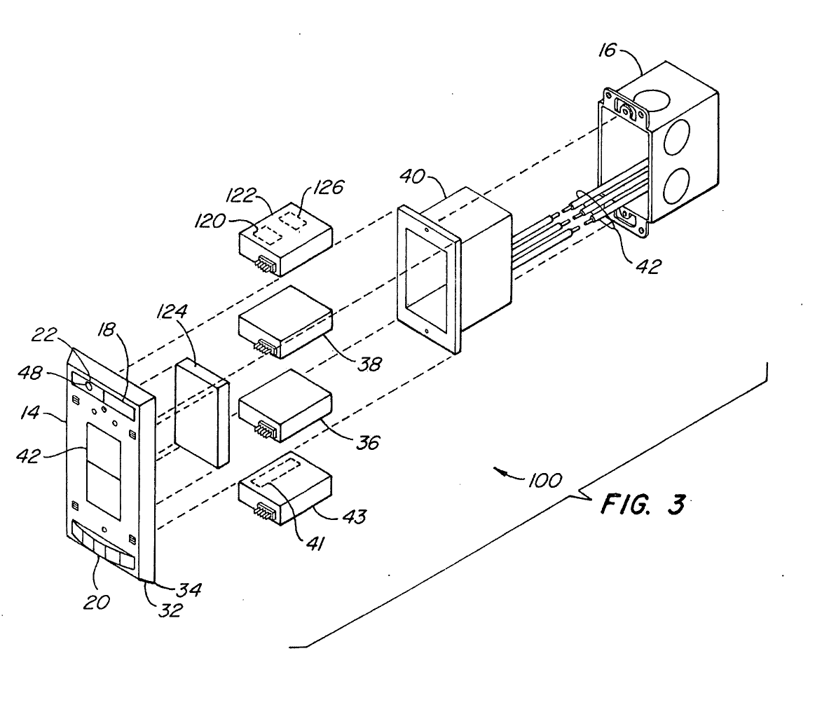

Referring to FIGS. 1-3, an embodiment of the invention is shown wherein an edge-of-network device 100 is used as replacement of a conventional wall-mounted light switch. The device 100 is adapted and modified so that sensory based electronics 12 are contained within a module whose form factor is consistent with a standard light switch and can be enclosed in a junction box housing 16. The light switch type junction box housing 16 contains sensors in the form of a passive infra-red (PIR) device 18 and motion detector 20 combined with a camera 22 on a microchip (not shown) embedded in the module and surrounded by a face plate 14. In combination, the sensors are operative to pick up activity passing by the light switch and to capture images. A control system 120 is provided in a first plug-in module 122 that plugs into a back panel mount 124 immediately behind and in electrical connection to the face plate electronics. The control system 120 for the devices typically self calibrates sensed activity to trigger the camera 22 according to a trigger input from the other sensors 18, 20 in order to take a best picture. A small pre-and post event buffer 126 captures audio and a small number of images over a period of time both before and after the trigger is fired in order to ensure that pertinent information is captured. (The camera is continually capturing images and temporarily buffering them, so that prior images can be stored once an event is triggered.)

The CPU of the controller 120 of sensory based electronics module 122 is centrally (remotely) programmable, and it allocates priorities, system resources, and communication in conjunction with a remotely located central controller device (not shown). The controller programs are created or modified remotely and transmitted via transceiver 38. The device 100 incorporates screw holes in standard positions to permit a face plate 14 to be screwed to it.

The face plate 14 has holes 18 though which the lenses for the miniature camera 22 and miniature infra-red detectors protrude, and other holes for the microphone, speaker, and other electronic components such as a motion detector or an odor detector. Otherwise, the face plate 14 is identical to and a direct replacement of a conventional face-plate.

In order to obviate problems from electrical interference and reduction in signal strength by containment inside such a relatively small housing as junction box 16, a radio frequency or other suitable communications transport antenna 32 is mounted in the structure forming front face of the edge-device module. Further, additional amplification stages 36 may be added to an RF transmitter driving the antenna 32 as part of a transceiver 38 which has full feature communication capabilities, including outgoing video and two-way audio, as well as two-way data and incoming control capabilities. The entire module set, except for the face plate 14, fits in a box 40 to which the face plate 14 is mounted, and the unit is connected to the power mains 42 with hot, ground and switching leads to control power to an electric circuit and to provide continuous power to the edge device. A holder 41 is provided to accommodate a battery in the power supply module 43 which assures long period operation even in the absence of mains power. A battery with adequate long-term capacity may be the primary source of power in alternative embodiments of the device. The battery is typically rechargeable and is supported by an appropriate charging circuit. A timer may be built into the module to assure that charging is not over done in the event the battery does not operate well as a trickle-charged battery.

In operation, a toggle switch 42 on the face plate 14 turns the electrical circuit controlled by the device on and off in the conventional manner. The circuit can also be turned on upon a fired trigger from the motion detector such as the passive infra-red receiver (PIR) 18 or other device, or upon special instruction from a peer-to-peer device (not shown) or upon a remote control source, such as central monitor station, a cell-phone or remote input to a web site.

Each light switch type device 100 according to the invention automatically ‘handshakes’ on an appropriate radio frequency connected to a central controller in the range of the radio, which in turn is in communication with a supervisory device, if needed.

Under power failure, the platform switches to battery power. Loss of power, combined with the sensing of unusual entry is highly indicative of break-in. The controller 120 may be programmed to save and/or transmit the contents of the event buffer 126 when loss of power occurs.

Timed triggers, motion detection or other triggers at a particular time can be enough to indicate aberrant behavior. For example, motion could be sensed in an office that is only used during the day. Such features may be subject of separate inventive contributions beyond the scope of this application.

The invention has been explained with reference to specific embodiments. Other embodiments will be evident to those of ordinary skill in the art. It is therefore not intended that the invention be limited, except as indicated by the appended claims.

What is claimed is:

1. A surveillance apparatus for use as an element of a surveillance system comprising:
a sensory subsystem at a network edge;
wherein said sensory subsystem is mounted in a conventional wall electrical enclosure.

2. The apparatus according to claim 1 wherein said wall electrical enclosure is a light switch box.

3. The apparatus according to claim 2 further including:
a light switch module integrated into said sensory subsystem for mounting in said wall electrical enclosure.

4. The apparatus according to claim 1 further including sensor elements in said sensory subsystem; and wherein said sensor elements include at least one of a video camera, a motion detector, a heat detector, a sound detector, and an odor sensor.

5. The apparatus according to claim 1 further including a local controller, wherein said local controller includes buffer memory.

6. The apparatus according to claim 1 further including:
a radio transceiver.

7. The apparatus according to claim 5 including an antenna mounted on said sensory subsystem.

8. The apparatus according to claim 6 including additional amplification stages driving said antenna.

9. The apparatus according to claim 4 further including:
a radio transceiver having at least two-way audio and at least one video channel for broadcast to a remote viewing platform.

10. The apparatus according to claim 4 further including:
a radio transceiver having at least two-way control communication and ability to receive programming instructions from a remote viewing platform.

11. The apparatus according to claim 1 wherein said sensory subsystem includes:
a power supply which is adapted to be coupled to mains power, and
means accommodating a battery for operation without external power.
